(19) United States
(12) Patent Application Publication
(10) Pub. No.: US 2014/0379381 A1
(43) Pub. Date: Dec. 25, 2014

(54) Method for Allowing Consumer Control Over Personal Healthcare Information

(71) Applicant: Red-Dash LLC, Marina Del Rey, CA (US)

(72) Inventor: Richard I. TURKANIS, Los Angeles, CA (US)

(21) Appl. No.: 14/483,087

(22) Filed: Sep. 10, 2014

Related U.S. Application Data
(63) Continuation of application No. 12/151,888, filed on May 9, 2008, now abandoned.
(60) Provisional application No. 60/928,854, filed on May 11, 2007.

(51) Int. Cl. G06F 19/00

(52) U.S. Cl. CPC G06F 19/322
USPC 705/3

(57) ABSTRACT

A method of gathering, storing, distributing and retrieving personal consumer medical information employs creating a consumer healthcare information account with the medical information stored in a database on a web server, issuing to the consumer a token having a unique identifying number that is linked to the consumer's account. The consumer may access the account information through use of a unique login name and password, but authorized third parties access or add to portions of the account information by using the token, with its unique identifying number. The consumer controls all aspects of data gathering and release. The token may also be used in a co-marketing program that provides the consumer with benefits for regular or frequent use.

### CROSS-REFERENCE TO RELATED APPLICATIONS

This application is a continuation of U.S. patent application Ser. No. 12/151,888, filed on May 9, 2008, entitled “Method for Allowing Consumer Control over Personal Healthcare Information,” which claims priority to U.S. Provisional Application No. 60/928,854, filed May 11, 2007, entitled “Method for Allowing Consumer Control over Personal Healthcare Information,” each of which is hereby incorporated by reference in their entireties.

### BACKGROUND

This disclosure relates generally to a method for allowing consumer control over gathering, distribution and use of personal healthcare information, and more particularly to a method for linking access to such information to a card, device or token commonly carried for other uses by the consumer. The linked item or token may maintain its original functionality but also act as a link to personal healthcare information. The token may further allow for a co-marketing component with the token issuer, including use in a use-rewards program.

Modern healthcare for an individual consumer often involves a large amount of information about the consumer and about the consumer's healthcare history. Preferably, at the time a consumer seeks medical attention, all of that information, or at least the relevant information, would be available to the healthcare provider. Often, and particularly during times of medical emergency or stress, consumers cannot remember their medical history and what medications they are taking, which may result in potentially serious consequences. Inability of medical personnel to access pertinent personal medical information at the time of healthcare delivery may lead to diagnostic and treatment errors, delays, and inefficiencies, resulting in increased mortality, morbidity and costs. Lack of integrated medical information systems across multiple physicians and hospitals and the increased mobility of modern society often exacerbate the situation.

The push for consumer-directed healthcare has been going on for some time. Many already use the Internet to gather information about medical conditions. As computers and the internet have become more commonplace, individuals have become more comfortable with, and recognize the benefits of, keeping financial records in a personal computer or stored in a secure online location. Online banking and checking are becoming increasingly popular. Just as consumers may gather, store and consolidate personal financial information from more than one bank or financial institution, consumers also need a similar process in healthcare, to permit consumers to gather, own and control personal healthcare records.

Consumers typically want web-based products and solutions such as online personal health records that are free of charge, easy to use and very secure. Consumers also typically want control over who has access to their personal health information, and often do not want such information shared with advertisers, marketers, drug companies, insurance companies, or employers. Furthermore, as the cost of healthcare continues to increase, many consumers have difficulty paying for prescriptions and routine healthcare and would welcome a rewards program that assists in paying for those healthcare needs.

Previously, attempts have been made to allow consumers to enter and store personal healthcare information on a personal computer or on the Internet. However, with prior methods it was often difficult to figure out how to control and manage the distribution of such information in various medical situations, such as in a medical emergency, during routine physician visits, or at the time of a hospital admission, and there has been limited adoption and use of such systems. Some solutions require the consumer to carry a special medical ID card or sticker that lists a web site, login name and password to access private personal and medical information. Others require the consumer to pre-print personal and medical information on a piece of paper to carry in a purse or wallet, or to wear a chain or bracelet indicating the consumer's medical condition.

Some prior solutions create a potential threat of identity theft or breach of privacy if the information is stolen or misplaced. Still other solutions require the consumer to give a login name and password to medical personnel each time they require access to medical records. This creates an administrative problem for the consumer and becomes difficult to do if the consumer is incapacitated during a medical emergency.

Still other solutions require the consumer's physician-or physicians to enter or update the consumer's medical record via a web site or by faxing medical documents to a specific phone number given uniquely to a registered consumer. This creates extra work for physicians who are not typically reimbursed for such additional work and thus may not complete such updates. Many of these prior solutions also require the consumer to pay a monthly or annual fee for such online medical record services. Such fees reduce adoption rates of such services. Many prior solutions also require the consumer to become a fairly advanced computer user during data entry and updating, again reducing adoption rates. Thus, for various reasons, these prior methods have not met with much success.

### SUMMARY

The present disclosure describes a method that allows consumer control with regard to gathering, distribution and use of personal healthcare information. According to one embodiment, a card, token, or device is carried by the consumer. The token may be an item already typically carried by a consumer, such as a credit card, that includes an additional feature, such as a specific graphic pattern around the edge of the card, so that the token may be easily and quickly identified as one used to access the consumer's medical information.

According to the present method, consumers may enter, gather, and track personal healthcare information, preferably without significant physician involvement. In consumer-identified situations, such as in a medical emergency, consumers may grant medical providers view only access to pre-selected personal healthcare information that is stored in a secure environment, without the need for the consumer to carry additional ID cards, paper printouts or bracelets, and without the need for the consumer to show or give anyone a password. The present method also allows control and distribution of personal healthcare information in various non-emergency medical situations, such as during routine physician visits or at the time of a hospital admission. Similarly, a consumer's prescription drug summary record may be gathered, entered and viewed, including pictures of medications.

The present method may provide for directed storage and distribution of the consumer's digital radiology images. The consumer may also pre-tag and fax or scan medical reports and personal documents into the online data store. According to one embodiment, consumers are rewarded for using the token in its original functionality by providing a mechanism to allow a rewards program help pay for certain prescriptions and routine healthcare.

According to the present method, a consumer opens an online personal health information account and links to that account a unique number that has been associated with the consumer's token. In one embodiment of the method, a credit card or ATM card number is used as the unique number. Although the card number is the link to the consumer's healthcare information, the setup, gathering, editing, and controlled distribution of such information requires an additional unique login name and password chosen by the consumer. The login name and password are known only to the consumer.

The data may be entered by processes known in the field, such as e-mail, web-access, digital file transfer, facsimile or even mailing the data to the keeper of the data store. The unique number associated with the token, the consumer's login name, and the account password together facilitate secure data gathering, storage, retrieval, access, and distribution. The data store is web-enabled, meaning that the consumer or medical providers authorized by the consumer may access the data store over the Internet.

One advantage of the present method is that the data is secure yet easily accessed or distributed in many differing circumstances under different levels of security. The consumer may select subsets of data requiring different levels of authorization for data retrieval or distribution under different healthcare provision scenarios. For instance, the consumer may authorize emergency responders to view one set of data if the consumer is conscious and cooperative, and another set if the consumer is unconscious. Family members may be authorized to view only certain subsets of data, such as prescription drug data.

Use of the token and access to the personal medical data may be triggered by one or more healthcare-related events. For instance, if the consumer goes to a doctor's office or hospital in a non-emergency situation, the consumer may use the token to address a web-enabled reader (such as by swiping the token), enter the account password, and request that a certain portion (or all) of the consumer's healthcare information be printed, e-mailed, transferred or otherwise made available, over the Internet, to the physician's or hospital's computer system. The consumer is able to identify what subset of information to provide in any given circumstance. This can assist in reducing data error, completion of medical forms, gathering of proper medical and medication history, and other such advantages.

In medical emergencies, the healthcare provider is preferably an authorized user of the method, such as a registered emergency facility or organization or an employee of such an organization. Each provider or facility has its own unique login name and password that it uses for authentication prior to accessing any data. Each such healthcare provider or facility may be granted a level of access that allows review of different subsets of the consumer's health information. Following successful login, the healthcare provider may be granted immediate view only access to parts or all of the identified consumer's medical information. The method creates and maintains a transaction log that identifies all attempts to access, and all information accessed from, each consumer's personal healthcare information account, so that if medical information is improperly accessed or used, the consumer might have a remedy against the violator.

In addition to providing access to healthcare data, the token might also be associated with a rewards program, analogous to a frequent flier program of an airline, that the consumer “joins” upon opening an online healthcare information account and receiving a token. Once the consumer acquires given “point” levels, the consumer might be entitled to transfer points into a “medical payment” account that subsequently can be used to help pay for prescriptions or routine healthcare visits. Use of such a program may generate increased affinity and loyalty to the organization that distributed the token. Acceptance of this “medical payment account” program by pharmacies and healthcare providers may also lead to increased loyalty by consumers to those entities.

### BRIEF DESCRIPTION OF THE DRAWINGS

Other features and advantages of the present invention will be apparent from the following Detailed Description taken in conjunction with the accompanying Drawings, in which:

FIG. 1 depicts a schematic overview of the physical elements of a typical environment in which one embodiment of the present method may be deployed;

FIG. 2 depicts a schematic view of a consumer setting up an account according to one embodiment of the present method;

FIG. 3 depicts a schematic representation of one aspect of a consumer use of an embodiment of the present method;

FIG. 4 depicts a schematic representation of replacement of a token according to one embodiment of the present method;

FIG. 5 depicts a schematic representation of use of a facsimile by a consumer according to one embodiment of the present method;

FIG. 6 depicts a schematic representation of one aspect of emergency use of one embodiment of the present method; and

FIG. 7 depicts a schematic representation of another aspect of emergency use of one embodiment of the present method;

FIG. 8 depicts a schematic representation of one aspect of non-emergency use of one embodiment of the present method;

FIG. 9 depicts a schematic representation of another aspect of a pharmacy use of one embodiment of the present method;

FIG. 10 depicts a schematic representation of a radiology use of one embodiment of the present method; and

FIG. 11 depicts a schematic representation of a co-marketing and co-branding use of one embodiment of the present method.

### DETAILED DESCRIPTION

The present method allows consumers to control the gathering, distribution, access, and use of personal healthcare information. The present method is typically rendered in a web-enabled application, so that the method may be practiced wherever there is an Internet connection. This provides a wide range of flexibility to the method.

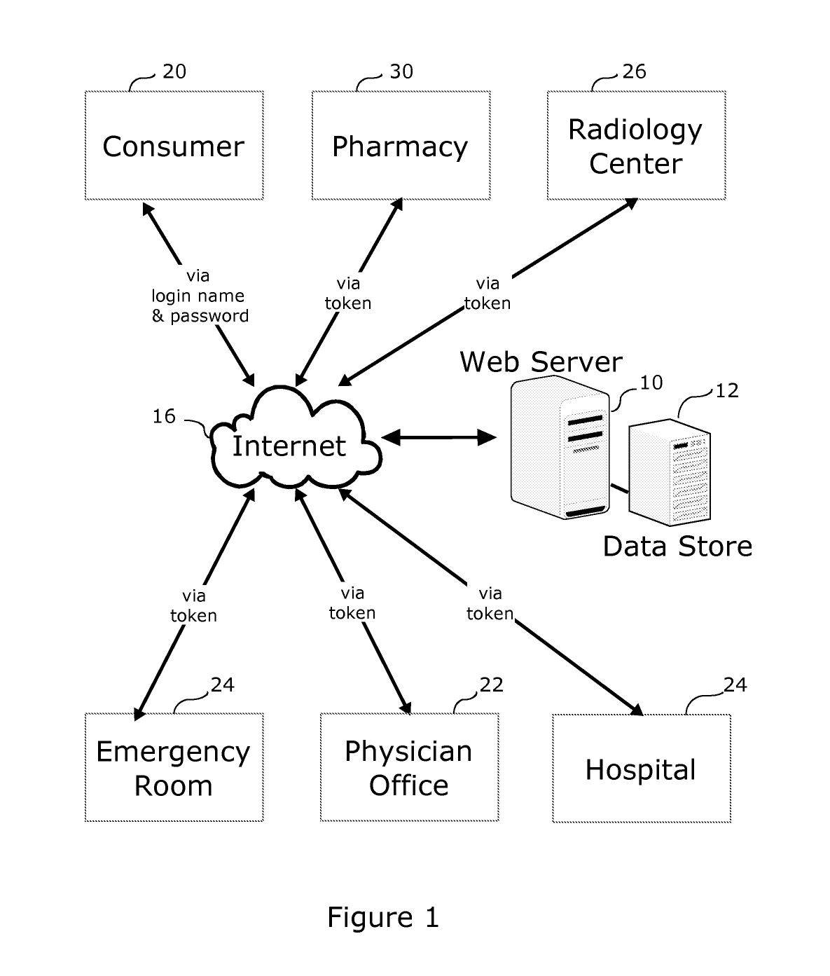

As depicted in FIG. 1, according to one embodiment of the present method, a web server 10 having a secure data store 12 (which may include multiple interconnected servers and data stores) is connected to the Internet 16 and enabled to permit a consumer 20 to communicate with the web server and data store. The method permits the consumer to transmit medical information to the data store as well as read or copy or modify or print any information in the data store, using techniques known in the art. Typically, the data store will allow secure individualized access to many consumers, each consumer having a unique account with a unique login name and a unique password to use to log on to the web server 10 and access that consumer's data (and no other data).

As depicted in FIG. 1, various third parties may access, add to, or receive portions of, the consumer's healthcare information stored on the web server 10, through the Internet or by other means. The consumer 20 controls such information flow by completing an account security setup for the consumer's personal healthcare information account. The consumer has several options, including providing prior authorization to access selected subsets of information in a future emergency, requesting certain pharmacy, radiology or medical record data to be uploaded by various third parties to the consumer's account, and delivering to third parties through various means selected portions of the information. This may be done from the consumer's home or at the time the consumer receives medical care, such as when at a physician's office 22 or hospital 24 or radiology center 26, or even when at a pharmacy 30.

For instance, an emergency room 32 might be authorized to view pre-selected medical information at the time of a medical emergency. The consumer may authorize the pharmacy 30 to upload or transfer, by itself or through a contracted third party, prescription drug information, including what prescriptions the consumer has received, what dosages the consumer should take, what restrictions there are on the prescription, the dates of refills, and other such information. A radiology center 26 might be authorized to upload x-rays and other image data, or might be allowed to view selected data from the consumer's prior radiology studies to perform proper comparison at the time of interpretation. A hospital 24 or physician's office 22 might be requested to upload certain information about medical care, costs, procedures, and the like. The consumer may control all such access, gathering and distribution of information stored in the consumer's account on the web server.

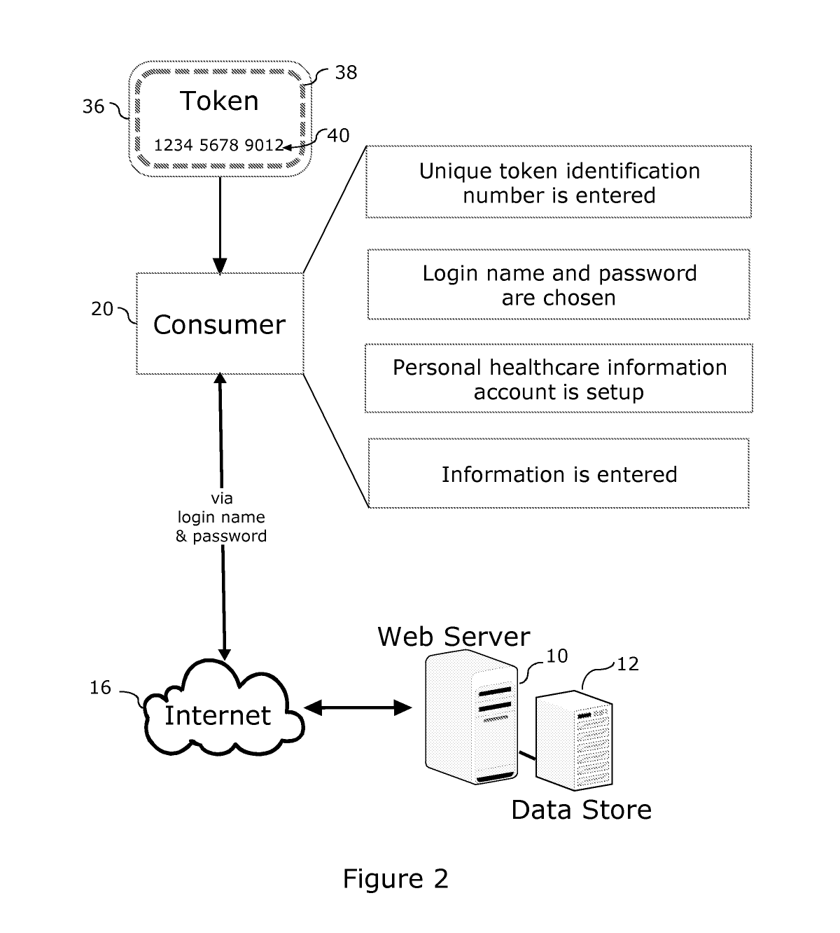

As depicted in FIG. 2, according to one embodiment, the consumer 20 expresses interest in the method and a sponsor, such as a credit card company, has a token 36 delivered by mail or by other means. The token might be any of several items already commonly carried by the consumer, such as a plastic card such as a credit, debit or ATM card, or a paper card such as a membership or insurance card, or an engraved item, or the token might be a key chain fob or a radio frequency emitting device, or a cell phone or digital music or video player. In many cases, the token will perform double duty, that is, the token will maintain its original function and also act as a linked medical information token. According to one embodiment, the token 36 is preferably an item normally carried by the consumer 20 for a primary purpose, such as a credit card (or debit or ATM card) having a primary purpose for paying at retail establishments or an organization membership card to identify members or a cell phone that is primarily a phone. However, the token 36 is also linked to the information account, and the token includes a graphic or logo or other visual identifier that indicates the presence of a link between the duel use token and the information account.

In these dual use instances, the token 36 has additional graphic markings 38 or logos that easily identify it as a linked medical information token. Alternatively, the token might have a peculiar shape or appearance that renders the token immediately recognizable, and may include a picture of the consumer to enhance identification. If immediately recognized, emergency responders are better able to take advantage of the existence of on-line medical information about the consumer, particularly if the consumer has been rendered unconscious or uncommunicative.

The token 36 has a unique identifying number 40 such as an account number or serial number (which may contain a combination of digits and other characters) written or embossed on the token, or possibly hidden but transmitted by radio frequency or other method from the token. Each token, together with its unique identifying number, is unique from all other tokens and is used to link such token to a unique consumer who has medical information available online through this method. This one-to-one relationship between the carried token and the specific consumer's healthcare records provides easy yet secure access to emergency and non-emergency medical information of the consumer, as well as a method for correctly and securely uploading pharmacy, radiology and other medical data to the proper consumer account. By selecting the specific type of token and entering its associated unique number, various third parties are able to access or upload data specific to that consumer's account without knowing the consumer's unique login name and password.

According to one embodiment, after receiving the token 36, the consumer 20 registers to use the method over the Internet 16 by using a browser to connect to the web server 10. The consumer enters the token type, unique token number, and, in some embodiments, an additional security number. The consumer 20 then chooses a unique login name and password, and an account is set up on the web server for that consumer.

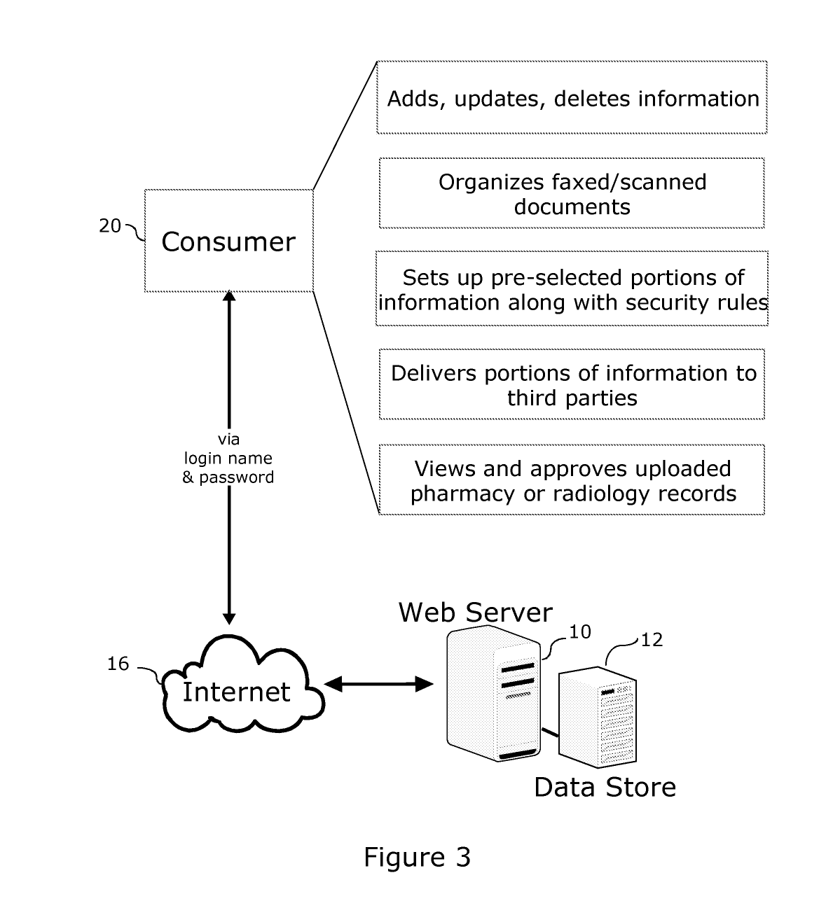

After setting up the account, the consumer 20 may begin to enter personal healthcare information into the account. Thereafter, the consumer may also directly add to, edit, or delete information stored on the web server 10. To perform this, as depicted in FIG. 3, the consumer logs on to the web server. The consumer's login name and password are verified, and the consumer selects which records to update.

While logged on, the consumer 20 may also print, email or fax different subsets (or all) of the consumer's records. The consumer may also select the various subsets of information to be viewed in various emergency and non-emergency future situations. As depicted in FIG. 3, the consumer, after logging into the account, can view and organize all uploaded documents by tagging them with various data fields, such as, for example, date of document production, type of document, privacy level, etc.

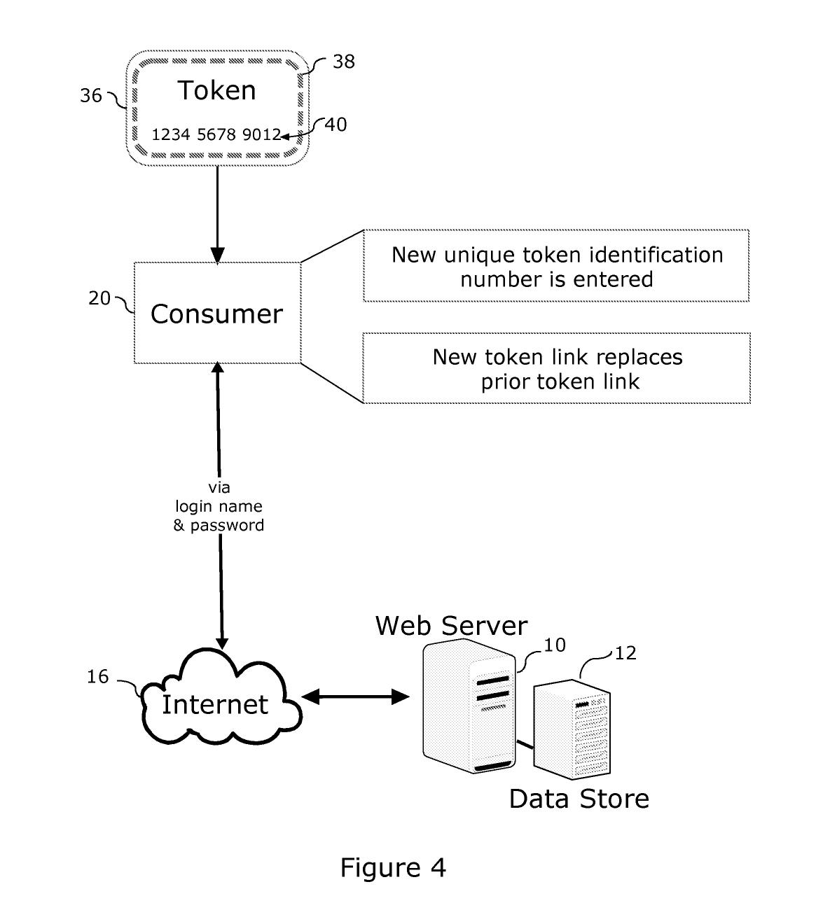

Unfortunately, there will likely be times when the consumer 20 loses or misplaces the token 36. There may also be times when the token is replaced by its sponsor or the consumer elects to change from one type of token to another type of token. As depicted in FIG. 4, when a new token is received by the consumer, the consumer logs on to the web server 10, and the consumer's account is confirmed by entering the unique login name and password. The consumer may then change the linked token by entering the new token type and new unique token identifying number, and perhaps by also entering an additional security number. The method then accepts the new token as the new “link” to the consumer's personal healthcare record account. An advantage of the method is that if a token is lost or misplaced, there is little chance of personal healthcare information being viewed or released because the token does not contain in printed form any such personal healthcare information, and does not contain any login name or password information. In addition, emergency information can not be obtained by someone who finds the lost card without being an authenticated user of the method.

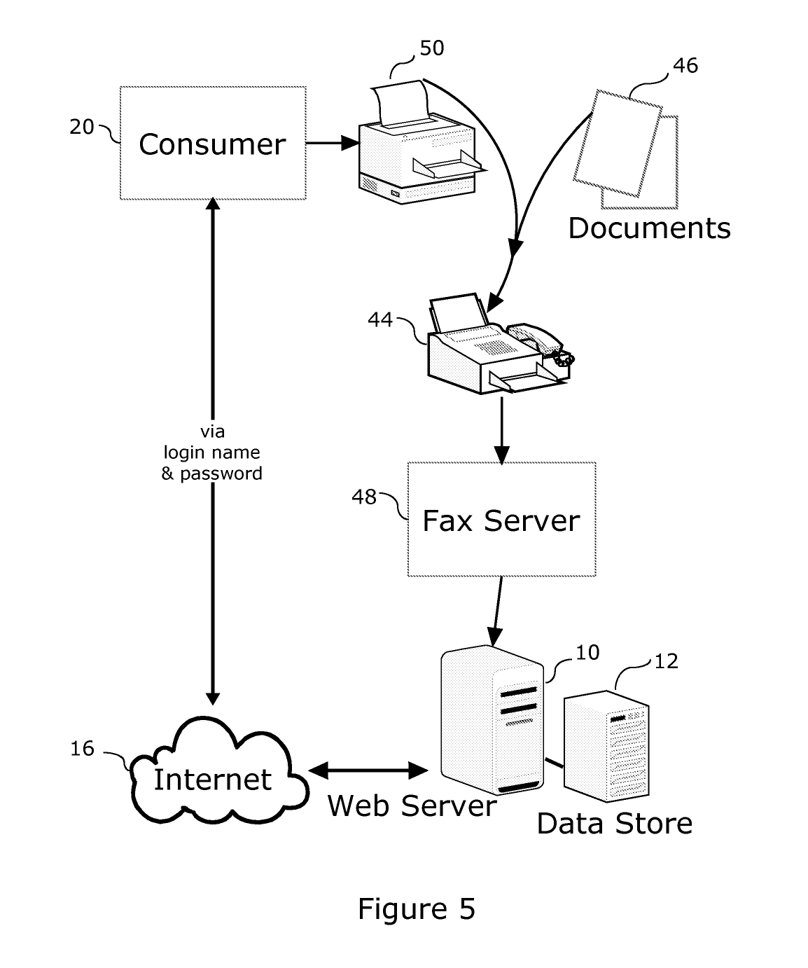

In addition to entering and changing healthcare information by typing into the web site, according to one embodiment of the present method, the consumer 20 has various other options for entering medical information in the data store 12. As depicted in FIG. 5, using a fax machine 44 the consumer may fax paper documents 46 to a fax server 48 for inclusion in the consumer's medical record. The consumer first logs securely into the account and then prints a fax cover sheet 50 that has printed on it some graphical representation, typically encrypted in one of many fashions. The fax cover sheet identifies the specific consumer's account. The fax cover sheet may also have additional fields, to be completed by the consumer, that are useful for linking the faxed medical information to the proper account. The consumer faxes the cover sheet together with the desired paper documents to a fax number associated with the fax server 48.

Upon receipt by the fax server 48, the cover sheet is processed by optical character recognition, or by other means, to determine the correct consumer account and the additional tagged fields used for filing purposes. The documents following the cover sheet data are converted into one of various formats and stored by the web server 10 in the consumer's account in the data store 12. In some embodiments, the consumer is allowed to enter medical information using standard telephone communications, or voice recognition software or a telephone menu tree.

Alternatively, as depicted in FIG. 1, the consumer 20 may log in to the web server 10 over the Internet 16, and upload images and documents to the web server. Similarly, the physician's office 22 may also upload medical records using e-mail (using the token 36, including an explanation of the type of token in some embodiments, and unique identification number 40 to identify the consumer's account) or using a facsimile machine to communicate with the fax server 48 in a manner similar to that depicted in FIG. 5. In these circumstances, the web server includes a recognition system that identifies to which consumer the transmission relates and loads the information into that consumer's account on the data store 12. Uploaded images and other documents that have been sent to the consumer's account may be stored in a digital image archive, which may be a part of the data store 12 or, in an alternative embodiment, may be stored in another location and still remain accessible over the Internet. As depicted in FIG. 3, after securely logging into the web server, the consumer may organize or reorganize the received documents into various subsets.

When registering for the method, or after registration is completed, the consumer 20 is able to make a number of choices concerning what, when and to whom various subsets of the consumer's data should be viewed or distributed. The consumer might elect to limit access to the consumer's information in the data store 12 to just the consumer, to emergency health-care providers, to specific members of the consumer's family, and to specific radiology centers or pharmacies used by the consumer. This access limitation may be enabled by use of various predefined options for the consumer to select while logged on to the web server 10.

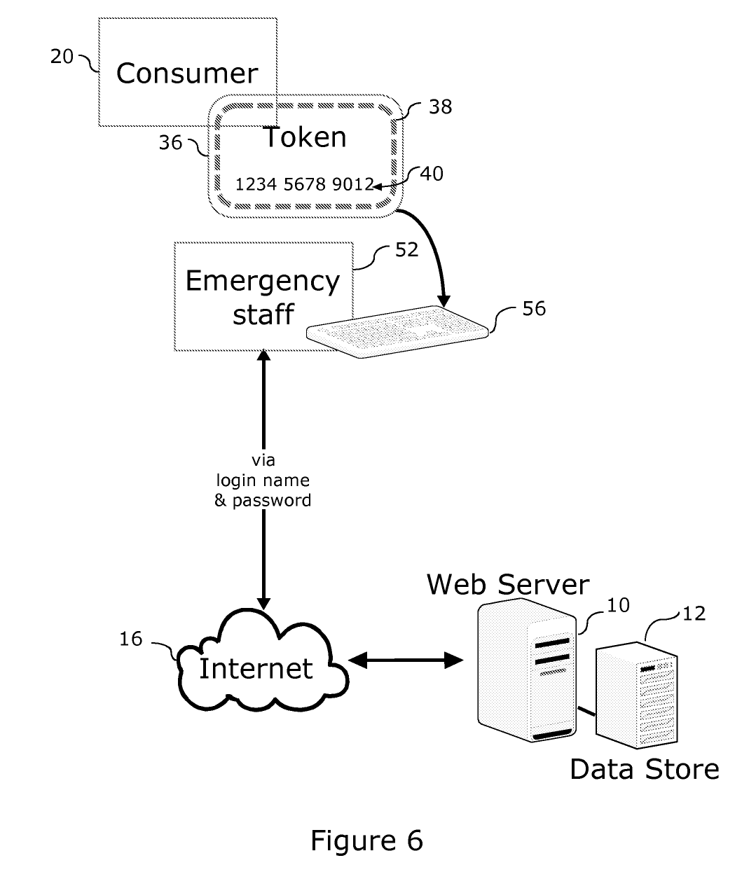

The present method is valuable in an emergency situation, especially when the consumer 20 is uncommunicative. For example, and as depicted in FIG. 6, shortly after contact with an unconscious consumer, emergency room 32 personnel may find the token 36. As mentioned, the token may have special identifying characteristics 38 to assist emergency room personnel in determining that the consumer has emergency medical information stored on the web server 10.

From the emergency room 32, emergency care providers 52 may log in to the web server 10. The emergency room 32 logs in to its own account, either at the facility or individual level, and then enters information about the consumer's token 36, such as the token type and its unique number 40 printed on or emitted from the token. Alternatively, the emergency room might swipe the token 36 through a card reader 56 to identify the unique token.

The emergency care providers 52 verify to the web server 10 that an emergency situation exists (which transaction is logged and recorded for later audit, if the consumer wishes). The web server then permits the emergency care provider view only access to whatever subset of medical information the consumer 20 has previously agreed to provide in such an emergency. Because the emergency room 32 has authenticated as itself to the web server, and there is an audit trail, the consumer has some assurance of personal privacy in this emergency situation.

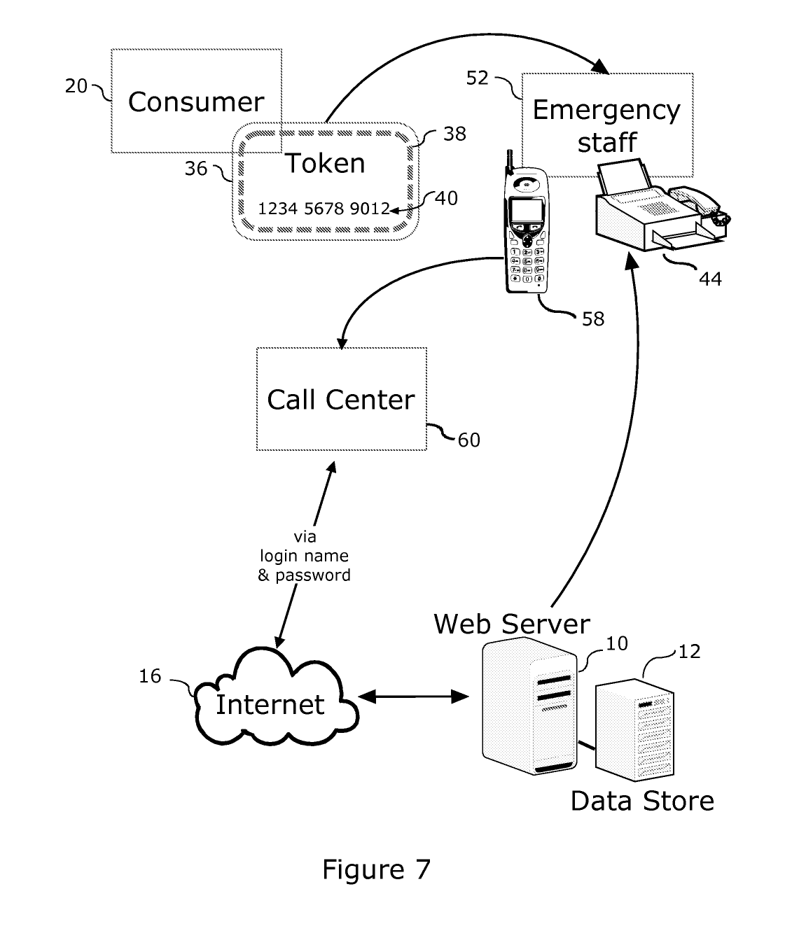

A similar emergency situation scenario is depicted in FIG. 7. In this scenario, the emergency care provider uses a telephone 58 rather than a computer to communicate with the web server 10, typically through an authorized call center 60 whose telephone number may be listed on the token 36, although other means are possible. This situation might include, for example, an ambulance team without current access to the internet. The emergency provider 52 authenticates to the call center 60 using the telephone, and the web server is then accessed by the call center, which might read over the telephone to the emergency provider, or send via facsimile 44 or e-mail to an emergency facility, a predetermined subset of consumer medical records.

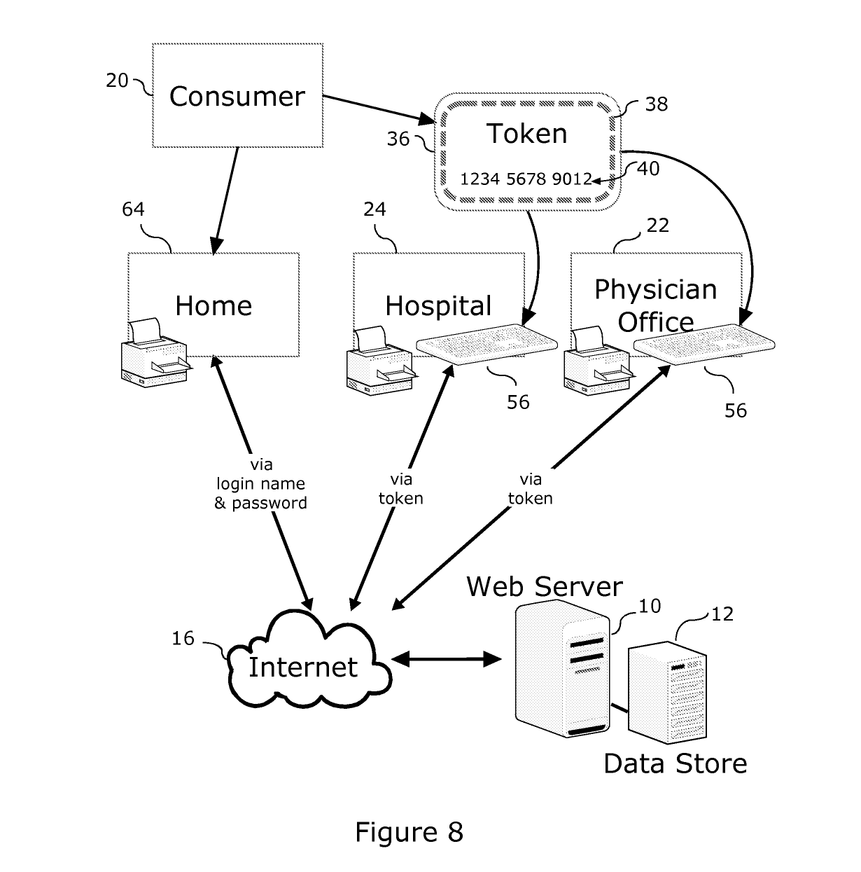

As depicted in FIG. 8, one of the benefits of the present method is that if the consumer 20 is planning to visit a physician's office 22 or hospital 24 the consumer can elect to print out a medical summary or registration packet at home 64 and carry it to the medical visit. Alternatively, upon arriving at the physician's office or hospital, the consumer 20 either logs in to the web server 10 with the unique login name and password, or if the physician's office is equipped with a card reader 56 and the token 36 is in the form of a magnetic stripe card, the consumer might login by swiping the token through the reader, followed by entry of the consumer's password. In this case, the consumer may elect to print out the registration packet or summary at that location. Alternatively, as depicted in FIG. 3, the consumer may direct a subset of the medical records to be emailed, faxed, or electronically sent to the physician's office 22 or hospital 24. All these result in a more efficient, more complete and less error-prone medical information gathering, which should lead to improved medical care, with less cost and less potential complications, duplicate test and drug interactions.

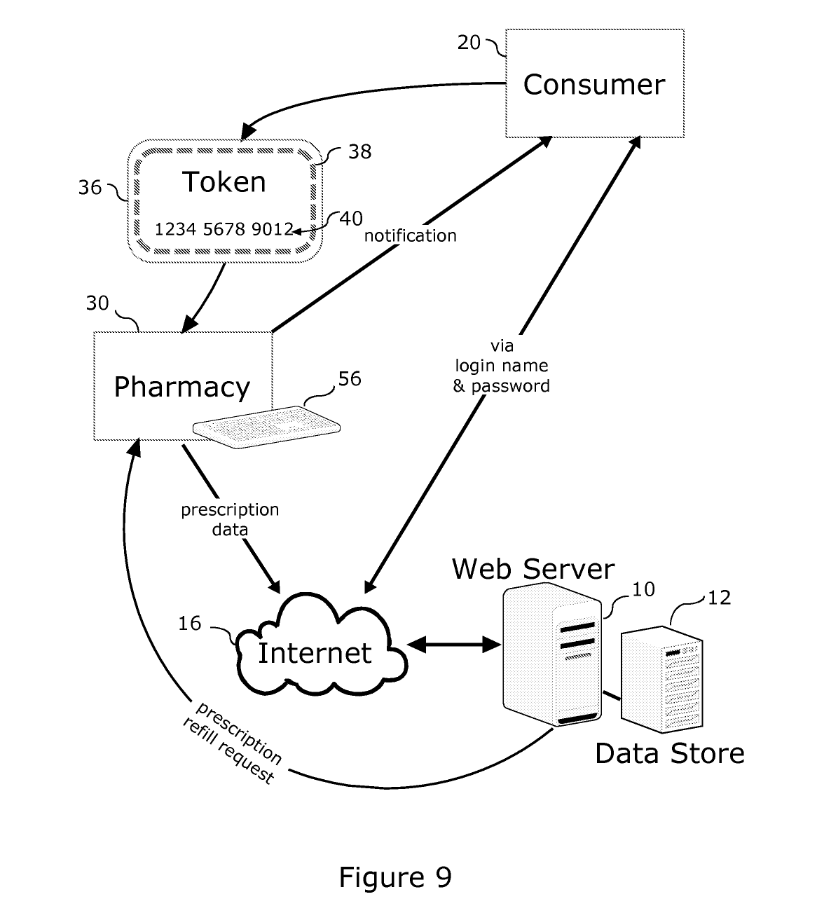

Another example occurs when the consumer 20 picks up prescriptions at a pharmacy 30, as depicted in FIG. 9. The consumer could request that the pharmacy, or a contracted third party, send a copy of the consumer's prescriptions to the consumer's health information account. In one embodiment, the unique identifying number 40 of the token 36 is given to the pharmacy so that the pharmacy, or a related third party, may provide that number to the web server 10 to identify the specific consumer account in which to store such received prescription information. The consumer would see and approve each such prescription upload when the consumer is logged into the account before such information is more formally entered into the consumer's record. At the time of approval, potential drug-drug interactions could be shown to the consumer, or the consumer could be notified by such by email or phone message from the web server.

In another example, if the consumer's preferred pharmacy 30 uses this method, the consumer 20 might be presented with the option of permitting that pharmacy to view some or all of the consumer's prescription drug information. Once enabled, the pharmacy 30 may log in to the web server 10 using the pharmacy's own account on the web server. Being authorized by the consumer to do so, and given the consumer's token 36 information (such as the unique identifying number 40), the pharmacy may then review the prescription drug information of the consumer to determine whether there are likely to be any drug interaction problems. If the token 36 is a magnetic card, the token information may be transmitted through a swipe of the token when the consumer is at the pharmacy. Alternatively, the pharmacy might receive a fax or e-mail from the web server 10, at the time of the prescription request or renewal, listing such consumer drug information.

Another pharmacy example may be derived from FIG. 9. Using a personal computer, the consumer 20 logs in to the web server 10 over the Internet 16. The consumer may order a prescription refill, and the web server notifies the pharmacy 30 via fax, email or other means. Potential drug interaction problems may be determined by the pharmacy, or the information may be provided to a national prescription drug database to check for, and report to the pharmacy on, drug interaction problems. The pharmacy 30 may then prepare the prescription for pick-up, including notifying the consumer that the prescription is ready.

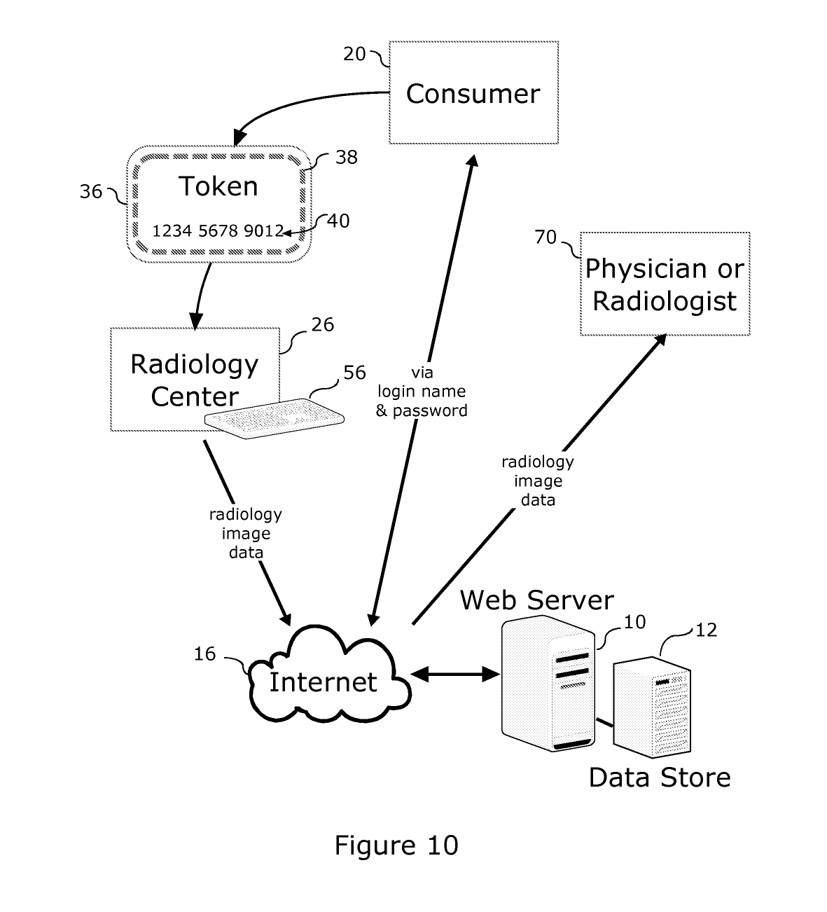

An example of radiological use of the method is depicted in FIG. 10. When a consumer 20 goes to a radiology center 26 for a radiology examination, the consumer may request that the radiology center send a digital copy of the images from that examination to a digital image archive, which is either part of the web server 10 data store 12 or is maintained by a third party and linked to the web server. In one embodiment, the unique identifying number 40 of the token 36 is used by the web server to identify the specific consumer account in which to store such received digital image information. The consumer may review and approve each radiology image upload when the consumer is logged into the account before such information is more formally entered into the consumer's record.

Afterwards, as depicted in FIG. 10, the consumer 20 may select prior radiology examinations that are stored in the consumer's account and forward them to a physician or radiologist 70 who requires them for comparison or medical decision purposes. Alternatively, the consumer could invite the physician or radiologist to review the images through a secure portal. The consumer may log in and retrieve copies of those images.

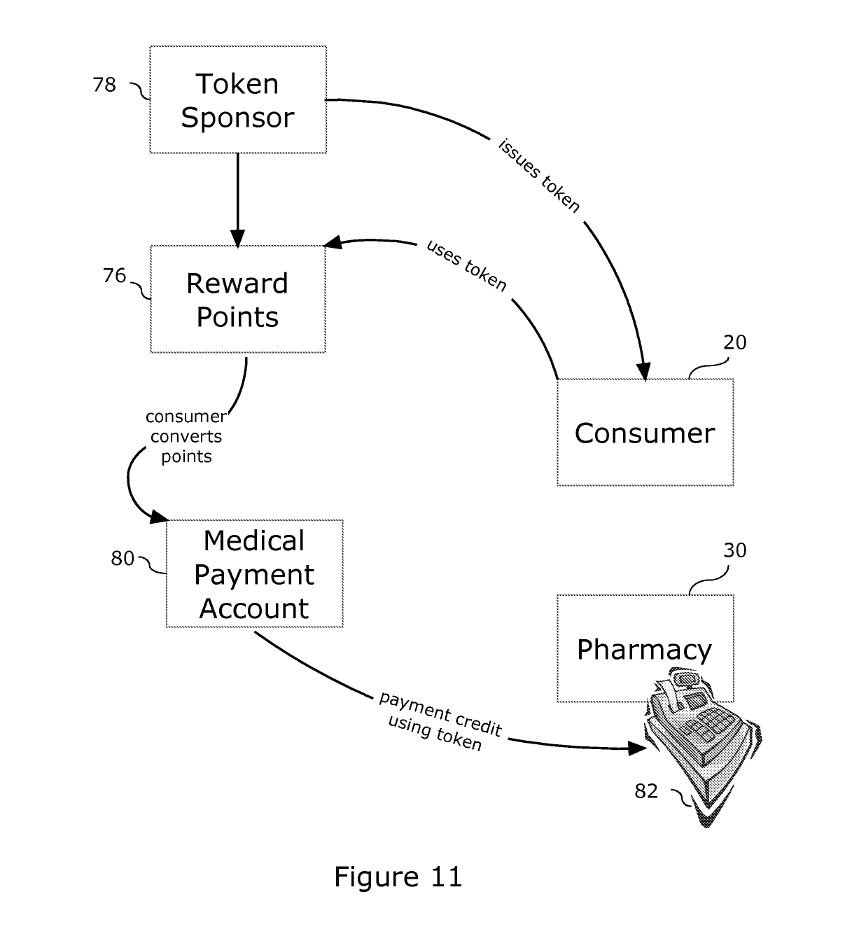

As depicted in FIG. 11, the present method may also be used in a co-marketing program such as a “frequent user” rewards program that the consumer 20 joins upon opening an account. According to this embodiment, the token 36 is issued by a token sponsor or issuer 76. The issuer may be any of numerous “membership” style organizations or companies, including issuers such as credit card companies, banks, cellular phone companies or membership organizations. The consumer 20 is awarded a certain number of points 78 for each use of the token 36. The consumer has the option to convert earned points into a “medical payment account” 80 that may be applied at the time of purchase to help pay for prescriptions and routine healthcare from partnering pharmacies 30 or healthcare organizations. Alternatively, the points could be converted to other benefits from the issuer, such as airline mileage points, “cash back” rewards, discounts, or other benefits.

In one embodiment, as depicted in FIG. 11, the consumer 20 requests the token issuing organization 78 to convert a specified number of points 76 into the “medical payment account” 80, such as seen, in one example, in gift cards. At the time of a pharmacy prescription purchase or routine healthcare visit, the consumer gives the token 36 to the cashier 82 who can access, using the token, the balance available in the “medical payment account” to help pay for such purchase. The consumer selects the amount to apply to the current purchase. Use of such a program may generate increased affinity and loyalty to the organization that distributed the token. Acceptance of this “medical payment account” program by pharmacies and healthcare providers may also lead to increased loyalty by consumers to those entities.

The present method allows a consumer to more effectively gather, maintain and control distribution of personal healthcare information on a long-term basis while maintaining the security and privacy of that information. Although described with regard to personal medical information, the present method may also be used for other private data, such as legal documents or dental documents or any other information that a consumer may wish to remain secure, yet provide access to third parties under certain circumstances. In addition to storing medical records in the data store, the consumer may store other types of electronic data for access by the consumer and those third parties the consumer decides to permit to review the data. Thus, the present method has several advantages over the prior art. It will be obvious to those of skill in the art that the invention described in this specification and depicted in the FIGURES may be modified to produce different embodiments of the present invention. Although embodiments of the invention have been illustrated and described, various modifications and changes may be made by those skilled in the art without departing from the spirit and scope of the invention.

1. A method for allowing consumer control with regard to gathering, distribution and use of personal healthcare information comprising the steps of:
establishing a personal healthcare information account for the consumer on a data store that is connected to a web server;
providing the consumer with a commonly carried tangible token that has a unique token identification number that is linked to the personal healthcare information account, the token further including a visually identifiable graphic pattern or logo, the token having a primary use generally unrelated to the personal healthcare information account;
allocating a unique login name and password for the consumer to use to communicate with the web server regarding the personal healthcare information account;
allowing the consumer to access the data store and thereby to view, to enter, to modify, and to print personal healthcare information in the data store;
enabling uploading of information to the personal healthcare information account via a facsimile that includes a cover sheet having account-identifying criteria and additional document tagging information;
enabling predetermined third parties to upload information into the personal healthcare information account by sending such data together with the token identification number to the web server, upon receipt of which the web server automatically enters the uploaded data into the personal healthcare information account without requiring the login name or password;
allowing the consumer to electronically deliver predetermined portions of the personal healthcare information to third parties;
making available to third parties portions of the personal healthcare information upon occurrence of a triggering event by a process comprising the steps of:
determining the type of triggering event and classifying the type as one of a medical emergency, a non-emergency physician or hospital visit, or a consumer-initiated event;
if the triggering event is a medical emergency, allowing view only access to a first consumer-defined portion of the personal healthcare information by an emergency provider based on possession of both the tangible token and a level of authentication that indicates the responder is associated with a registered emergency healthcare provider, and without the need for the provider to know the login name or password;
if the triggering event is a non-emergency, allowing view only access to a second consumer-defined portion of the personal healthcare information by a third party based on possession of both the tangible token and a level of authentication that indicates the third party is a known registered entity, and without the need for the third party to know the login name or password;
if the triggering event is a consumer-initiated event, allowing access to a third consumer-defined portion of the personal healthcare information by requiring the consumer to:
log in to the data store using the login name and password;
select the personal healthcare information to be contained in the third portion; and
send an invitation to a third party to provide view only access to the third portion for a limited time period; and
creating and maintaining a transaction log that identifies all accesses and attempted accesses to the personal healthcare information stored in the account.

2. The method of claim 1 wherein the token is a card.

3. The process of claim 1 wherein the token is an electronic device.

4. The method of claim 1 wherein the token includes co-branding with an issuer of the token.

5. The method of claim 1 wherein the personal healthcare information includes digital radiology images entered into the data store by a third party.

6. The method of claim 1 wherein the personal healthcare information includes prescription drug information entered into the data store by a third party.

7. The method of claim 1 wherein points earned by using the token are convertible into a medical payment account to be used to assist the consumer in paying for prescribed drugs or other healthcare services.

8. A method for managing personal information comprising the steps of:
establishing an information account for a consumer on a web server;
allowing the consumer to communicate data to and from the information account on the web server using a unique login name and password;
providing the consumer with a token that has a unique token identification number linked to the information account;
enabling predetermined third parties to transmit data to the information account together with the token identification number, upon receipt of which the web server enters the data into the information account without requiring the login name or password;
making available to third parties portions of the personal information upon occurrence of a triggering event by a process comprising the steps of:
if the triggering event is an emergency, allowing view only access to a first predetermined portion of the personal information by an emergency provider based on possession of both the tangible token and a level of authentication that indicates the provider is associated with a registered emergency provider, and without the need for the provider to know the login name or password;
if the triggering event is a non-emergency, allowing view only access to a second predetermined portion of the personal information by a third party based on possession of both the tangible token and a level of authentication that indicates the third party is a known registered entity, and without the need for the third party to know the login name or password;
if the triggering event is a consumer-initiated event, allowing access to a third predetermined portion of the personal information by requiring the consumer:
to log in to the web server using the login name and password;
to select the personal information to be contained in the third predetermined portion; and
to provide view only access to the third predetermined portion to a third party for a limited time period.

9. The method of claim 8 wherein the token includes a visually identifiable graphic.

10. The method of claim 8 wherein the token has a primary use generally unrelated to the information account.

11. The method of claim 8 wherein the consumer communicates with the personal information account via a facsimile that includes a cover sheet having account-identifying criteria.

12. The method of claim 8 wherein the token is a card.

13. The process of claim 8 wherein the token is an electronic device.

14. The method of claim 8 wherein the token includes co-branding with an issuer of the token.

15. The method of claim 8 further comprising the step of creating and maintaining a transaction log that identifies all accesses and attempted accesses to the personal healthcare information stored in the account.

16. The method of claim 8 wherein the personal information includes medical images provided to the information account by a third party.

17. The method of claim 8 wherein points earned by using the token are convertible into a benefit account for the consumer.

18. A method for managing personal information comprising the steps of:
establishing on a web server an information account over which a consumer controls entry of, deletion of, modification of, and distribution of any data loaded therein;
providing the consumer with a token having a primary use generally unrelated to the existence of the information account; and
linking a unique token identification number to the information account.

19. The method of claim 18 further comprising the step of making a predetermined portion of the data in the information account available to a predetermined type of third party based upon proper authentication by the third party and upon at least one of:
possession by the third party of the token;
knowledge by the third party of the token identification number; or
an invitation from the consumer to the third party.

20. The method of claim 18 further comprising the step of making available predetermined portions of the data upon occurrence of a triggering event by a process comprising the steps of:
if the triggering event is an emergency, allowing view only access to a first predetermined portion of the data by an emergency provider based on possession of both the tangible token and a level of authentication that indicates the provider is associated with a registered emergency provider, and without the need for the provider to know the login name or password;
if the triggering event is a non-emergency, allowing view only access to a second predetermined portion of the data by a third party based on possession of both the tangible token and a level of authentication that indicates the third party is a known registered entity, and without the need for the third party to know the login name or password;
if the triggering event is a consumer-initiated event, allowing access to a third predetermined portion of the data by requiring the consumer:
to log in to the web server using the login name and password;
to select the data to be contained in the third predetermined portion; and
to provide view only access to the third predetermined portion to a third party for a limited time period.

21. The method of claim 18 further comprising the step of creating and maintaining a transaction log that identifies all accesses and attempted accesses to the personal information stored in the account.

22. The method of claim 18 further comprising the step of enabling third parties to transmit data to the information account based on the token identification number, upon receipt of which the web server enters the data into the information account.

23. The method of claim 18 wherein points earned by using the token are convertible into a benefit account for the consumer.
